(19) United States
(12) Patent Application Publication
(10) Pub. No.: US 2009/0322859 A1
(43) Pub. Date: Dec. 31, 2009

(54) Method and System for 3D Imaging Using a Spacetime Coded Laser Projection System

(76) Inventors: Damion M. Shelton, Pittsburgh, PA (US); Micle K. Formica, Runer, PA (US)

Correspondence Address: The Law Firm of Carl A. Ronald, 20436 Route 19, Suite 620 #146, Cranberry Township, PA, 16066, US

(21) Appl. No.: 12/408,590

(22) Filed: Mar. 20, 2009

Related U.S. Application Data
(60) Provisional application No. 61/070,086, filed on Mar. 20, 2008.

(51) Int. Cl. H04N 13/02; G06T 15/00

(52) U.S. Cl. 348/46; 345/419; 348/E13.074

(57) ABSTRACT

A desktop three-dimensional imaging system and method projects a modulated plane of light that sweeps across a target object while a camera is set to collect an entire pass of the modulated plane of light over the object in one image to create a line stripe pattern. A spacetime coding scheme is applied to the modulation controller whereby a plurality of images of line stripe patterns can be analyzed and decoded to yield a three-dimensional image of the target object in a reduced scan time and with better accuracy than existing close range scanners.

### CROSS REFERENCE TO RELATED APPLICATIONS

This application claims the benefit of U.S. Provisional App. No. 61/070,086, filed Mar. 20, 2008, the disclosure of which is incorporated by reference in its entirety.

### BACKGROUND OF THE INVENTION

The present invention generally relates to a method and apparatus for three-dimensional (“3D”) shape measurement using a spacetime coded, structured light laser projection system. More specifically, the invention relates to a “desktop 3D scanner” that is small enough to fit on a conventional table or desk, connects directly to a laptop computer or workstation, integrates with a 3D modeling or CAD application, and dramatically reduces the time required to build a 3D model of an object.

3D imaging systems are widely used for acquiring the shape of an object for purposes of reverse engineering, rapid prototyping, computer game and film animation, graphic design, industrial process control, medical analysis, and numerous other fields. Prior art techniques for constructing 3D imaging systems can broadly be summarized into four categories:
1. Coordinate measuring machines, which derive the shape of an object by requiring the operator to touch a contact probe to the surface of the object being measured;
2. Illumination time-of-flight (“TOF”) systems, which measure the distance to individual points on an object by computing the travel time of a discrete pulse of light;
3. Stereo vision techniques, which rely on feature identification and triangulation between multiple views of an object; and
4. Structured light techniques, which rely on the known geometry and time evolution of an illumination source.

With respect to desktop 3D scanners, desirable characteristics include high accuracy (<1 mm error), near field (0-3 meters working distance), and high-speed (<1 minute scan time). While the term “desktop” is used, the scanners of the present invention need not be used solely in an office environment; their small size and light weight enables mounting on a tripod, handheld use, or attaching the scanner to another device such as a mobile robot or factory automation tool.

Coordinate measuring machines, while highly accurate, are also extremely slow and operator intensive, making them impractical for creating complete models of complicated objects due to the large amount of time required to collect the large amount of separate data points for such a model. Time-of-flight systems usually have a large minimum working distance compared to the other three methods (generally several meters), which precludes their use for near field measurement. In addition, because distance measurement accuracy in a time-of-flight system is directly related to timing accuracy, such systems often have a relatively coarse resolution on the order of several millimeters to several centimeters. Finally, stereo vision techniques are able to acquire data very quickly and can easily adapt to near field operation by simply changing the camera optics. However, stereo systems fail to work on objects that have sparse surface features, because these features are used to establish correspondences between the cameras in the system and derive the surface model. As an example, a smooth surface with a uniform finish would be difficult or impossible to image with a stereo system.

The limitations of the first three techniques have driven a great deal of interest in using structured light for desktop 3D scanners. Note that in the context of structured light systems, the terms “3D imaging” and “3D scanning” are generally construed to be synonymous. Structured light techniques all share the common feature of illuminating the target object with a light source that can be characterized temporally, spatially, or both. Temporal constraints typically involve a fixed geometry illuminant being swept over an object over a certain period of time. Spatial constraints, on the other hand, involve the projection of a fixed illuminant with a known geometry, such as a parallel series of stripes, onto the object to be imaged. Combination of the two constraints involves projecting patterns that change both spatially and temporally and is known in the art as “spacetime variation”. Each of these classes of structure light systems will be discussed for clarity.

Structured Light with Temporal Variation

One of the first practical, commercially available 3D scanners is described in U.S. Pat. No. 4,705,401 (the '401 patent). This patent describes the fixed illuminant, time-varying approach to structured light. Specifically, the '401 patent uses a plane of light with a known, fixed angle relative to a camera to illuminate a rotating object. By observing the projection of the laser plane onto the surface of the object to be imaged with a camera, the position of points on the surface of the object can be calculated using known mathematical techniques. Similarly, a system described a year earlier in U.S. Pat. No. 4,627,734 (the '734 patent), used a moving illumination plane across the object to be imaged rather than a rotating scan target. Nearly all commercially available 3D scanners that would meet the previously described characteristics of a “desktop scanner” utilize the general techniques (in aggregate, known in the art as “line stripe triangulation”) described in the '734 and '401 patents.

While line stripe triangulation, particularly if implemented using a laser as the light source, offers many advantages over more technically advanced, modern approaches, it has one severe disadvantage, namely long acquisition/scan times. In a laser line-stripe triangulation system, the number of points measured by the scanner (the scan resolution) is directly proportional to the number of discrete angular positions occupied by the laser plane. One camera image of the object as illuminated by the laser line-stripe must be acquired at each discrete angular position of the laser plane. In a typical implementation, the number of discrete angular positions of the laser plane must be greater than or equal to the camera sensor resolution in order to yield full coverage of the camera sensor. In other words, for a hypothetical 1000×1000 camera sensor, the laser must be stepped through a minimum of 1000 discrete angles and an image acquired at each angle. This process yields, in most present implementations of line-stripe systems, the requirement to capture a very large number of images.

Structured Light with Spatial Variation

The second class of structured light systems includes systems where the illuminant does not change through time, but rather varies spatially over the surface of the object being imaged. Such systems only require a single camera image of the object, since the illuminant does not change over time, and therefore offer performance approaching real-time. Any of a wide variety of spatially varying illuminants may be used to implement a structured light system with spatial variation. Patterns that are known in the art include, for example, color-encoded fringe images, black and white bars with hard edge transitions, and laser fringe images.

Many structured light systems that employ a spatial-only constraint produce what is known as a phase map, which is a measure of the depth of each pixel in the camera image modulus the wavelength of the projected fringe image. In other words, rather than yielding an absolute depth measurement for each pixel in the camera image, the phase map “wraps” from 0 to 2π, with no value smaller than 0 or greater than 2π. In order to produce an absolute range image, where each pixel in the image contains the actual distance from the imaging device to the object being imaged, the phase map must be “unwrapped”. Numerous phase unwrapping techniques exist and are known both in the art and in many other application areas such as radar, computed tomography medical scanners, and ultrasound imaging. Critically, phase unwrapping relies on the assumption of a continuous surface, because any discontinuous portions of the phase map would have ambiguous depth relative to each other, there being no intrinsic absolute coordinate frame. In other words, using structured light with spatial variation requires phase unwrapping, which, in turn, limits the types of objects that can be reliably scanned.

Structured Light with Both Spatial and Temporal (Spacetime) Variation

A third class of structured light systems is a combination of both spatial and temporal variation (“spacetime” variation). Spacetime systems use a spatial coding pattern that also changes through time, and numerous coding schemes have been proposed in the prior art.

Most similar to spatial encoding schemes are those spacetime encodings which produce phase maps rather than absolute depth measurements as set forth, for example, in U.S. Pat. App. No. 2007/0115484. Much like other phase systems, the phase map must be unwrapped to yield an absolute depth map, which severely limits the types of objects that can be reliably scanned. The majority of spacetime encoding schemes, however, result in absolute depth measurements because they employ a larger number of images. These systems are often referred to as “binary coded structured light”, and are also well-known in the art dating back to 1981.

Binary coding schemes work by dividing the illuminant plane into spatial regions that have distinct codes when viewed over time. Because the code itself consists of a number of binary values, the camera need only be able to distinguish between presence or absence of an illuminant, making such codes extremely robust against noise. In a typical implementation of a binary coded structured light system, a series of planar light images is projected upon the object to be imaged. Simultaneously, a camera records one frame for each image. Decoding the captured pattern of light and dark values for each pixel in the camera image yields the value of the depth of the camera pixel in question.

Methods for decoding binary illumination codings and computing the geometric relationships involved are well known in the art, and numerous practical implementations exist. In practice, straight binary encoding is subject to large coding errors, and hence large angular errors, if the system fails to correctly decode a camera pixel as being light or dark. This is quite common along the border between light and dark stripes, and also occurs when the contrast between light and dark stripes is low due to surface finish effects. Alternative encoding schemes are therefore frequently used, most importantly the Gray code. Gray codes have the important advantage over straight binary codes that single bit errors in the decode process only result in an angular error of one unit. From digital signal processing perspective, neighboring codes can be thought of as having a Hamming distance of 1, since any two neighboring angular codes differ by identically one binary bit.

One common problem with both Gray and binary coding schemes is that extremely fine details can be difficult to resolve. Hypothetically, optimal resolution in a Gray or binary coding scheme can be obtained when the physical spacing between adjacent codes in the projected image maps to adjacent pixels in the camera image. In practice, since both Gray and binary codes require the camera to distinguish between “on” and “off” illuminant values, attempting to shrink the physical size of the projected code to this level results in ambiguity in the decoded value whenever a stripe does not exactly align with a camera pixel. In most modern implementations of Gray and binary coded structured light systems, the smallest stripe actually projected is chosen to be substantially wider (>10×) than the width of a pixel when viewed with the camera. Final refinement of the decoded angle for each pixel occurs by projecting a set of phase shifted, extremely thin stripes, proposed by Sansoni in 1997 and 1999, and Guhring in 2001.

Known methods for projecting spacetime coding schemes include slide film projection, liquid crystal display (LCD) video projectors, and Digital Light Processor (DLP) projectors. It is important to note that, broadly speaking, the choice of projector type (slide film, LCD, or DLP) is independent of coding scheme. In other words, a system using a DLP projector could project either a binary code or Gray code, with or without a set of phase shifted stripes. Similarly, a particular coding scheme can be projected using any of the three listed projector technologies.

While structured light analysis can greatly decrease the amount of time needed for 3D scanning, it has substantial technical limitations that have greatly limited commercial adoption until now. First, the projectors used to display the lines on the object suffer from a problem with depth of focus. These projectors are designed for display on flat surfaces and result in a blurry image in front of or behind the desired focal plane when attempting to scan a 3D object. Second, most video projectors are relatively large and heavy compared to modern digital imaging hardware and are not practical for many types of imaging. Finally, the greater the resolution of the projector and the lighter the weight, the more expensive it is. Therefore, there is a need for a new method and device for scanning 3D objects that is faster, more accurate, less costly and lighter than existing prior art methods and devices.

### SUMMARY OF THE INVENTION

The present invention comprises methods and systems for three-dimensional imaging of a target object. In accordance with an aspect of the present invention, a system for three-dimensional imaging of a target object comprises a light source, a light source controller for modulating the intensity of the light, one or a plurality of reflective surfaces for reflecting the light onto the target object to be scanned, a reflective surface controller for altering an angle of the one or a plurality of reflective surfaces relative to the target object so that the modulated reflected light is periodically swept across the object to be imaged, with each periodic sweep displaying a stripe pattern on the target object, a detection means for capturing and recording the stripe pattern and a processor for varying the stripe patterns over time to record a plurality of stripe patterns displayed on the target object with the detection means. Preferably, the of stripe patterns thus created forms a spacetime coding scheme that can be analyzed to yield a three-dimensional image of the object. In addition, the light source may be a laser, a line stripe generator or some other source of a plane of light.

In accordance with another aspect of the present invention, the light source controller modulates the intensity of the light in a predetermined pattern, which can be a spacetime coding scheme such as a Gray code or a binary code.

In further accord with the present invention, the reflective surfaces may be mirrors, a galvanometer or a polyhedral object having a plurality of reflective surfaces, which object is made to spin at a constant or nearly constant speed about a central aspect. In addition, the detection means may be a camera that records each stripe pattern on a plurality of pixels and with a plurality of stripe patterns, a time-history for the plurality of pixels can be created whereby discrete illumination angles can be calculated and, correspondingly, the distance from the camera to each part of the target object.

In yet another aspect of the invention, a method for three-dimensional imaging of a target object comprises periodically sweeping a plane of light across an object, modulating the intensity of the plane of light in a predetermined pattern as it sweeps across the target object, recording an entire sweep of the plane of laser light in a single image to create a stripe pattern, collecting a plurality of images of stripe patterns displayed on the target object over time and extracting three-dimensional image data from the plurality of images of stripe patterns. Additionally, the plurality of images of stripe patterns comprises a spacetime coding scheme such as a Gray code or a binary code. Further, the plurality of images can be comprised of a plurality of pixels so that the three dimensional image data can be extracted by deriving an illumination angle for each of the plurality of pixels relative to the light source. An additional aspect of the invention is that the illumination angle for each of the plurality of pixels can be used to derive a plurality of distance measurements from the camera to the target object and thus create a three dimensional image of the object.

### BRIEF DESCRIPTION OF THE DRAWINGS

For the present disclosure to be easily understood and readily practiced, the present disclosure will now be described for purposes of illustration and not limitation in connection with the following figures, wherein:

FIG. 1 is a schematic diagram showing a preferred embodiment of the spacetime coded laser projection system of the present invention.

FIG. 2 is a flow chart illustrating the process flow for obtaining a 3D image of an object in accordance with one embodiment of the present invention.

FIG. 3 is a flow chart illustrating the process flow for obtaining a 3D image of an object in accordance with an alternative embodiment of the present invention.

FIG. 4 is a schematic diagram showing the projection of a single frame of the spacetime coding scheme in one embodiment of the present invention.

### DETAILED DESCRIPTION OF THE INVENTION

In the following detailed description, reference is made to the accompanying examples and figures that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims and their equivalents.

The present invention takes account of the relative strengths and weaknesses of the single line stripe triangulation method and the multiple line structured light method and provides for the merger of these two disparate techniques to provide a laser-based structured light system that achieves laser-line accuracy at the speed of a structured light system.

A review of structured light technology yields a simple, yet significant observation: the line projection need not be limited to a general-purpose video projector. Unlike all known systems that use a white light projector, whether implemented with an LCD or DLP light modulation device, the present invention uses a combination of a moving mirror and laser line source to project the structured light image. Unlike the laser line-stripe systems described in the '401 patent and the '734 patent, the present invention images a plurality of stripes simultaneously and varies the pattern of stripes through time to form a spacetime coding scheme. And, unlike the system described in U.S. Pat. No. 7,298,415 (the '415 patent), the present invention is not limited to producing a phase map and instead returns absolute pixel ranges rather than relative phase information.

The present invention operates as follows: a plurality of images, referred to as “frames”, form a spacetime coding scheme that assigns a planar illumination angle to all points on the surface of a target object. Each individual frame of the spacetime coding scheme consists of a plurality of illumination stripes of varying intensities. Each image in the spacetime coding scheme is projected onto a target object by means of laser light that is reflected off of a moving mirror. The illumination of the target object is observed by one or more cameras. By synchronizing the start of the mirror movement with the start of camera exposure, the camera will integrate the varying laser intensity during the mirror's motion into a single image of the target object as illuminated by the spacetime frame in question. Each successive repetition of mirror movement and laser modulation results in one image of the spacetime coding scheme being recorded by the camera.

After all images have been projected, the image sequence from the camera is decoded to form a plurality of depth measurements—one measurement per pixel in the camera—from the camera focal plane to the surface of the object. Note that although subsequent diagrams and descriptions refer only to a single camera, techniques for aligning and merging range image measurements from multiple cameras are well known in the art and the present invention in both its preferred and alternative embodiments may contain either a single camera or multiple cameras without loss of generality.

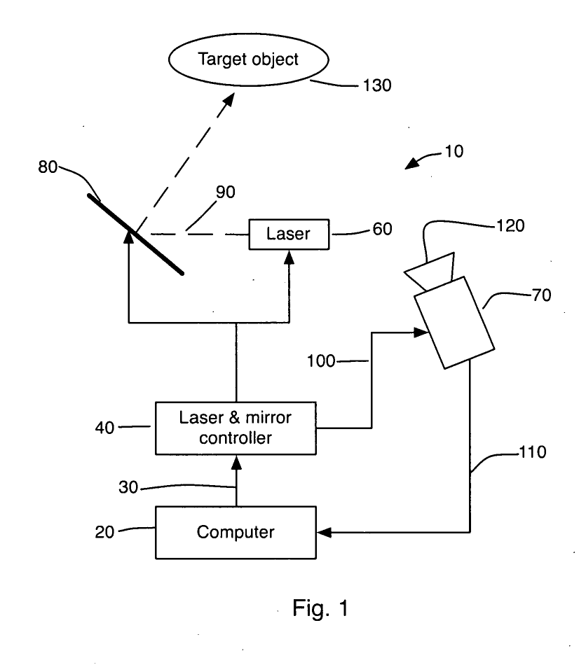

According to FIG. 1, a preferred embodiment of the 3D imaging system 10 of the present invention includes a general purpose digital computer 20 running a desktop operating system such as Linux or Microsoft Windows. An alternative to the general purpose computer 20, however, is an embedded system that communicates with additional hardware external to the scanning system, which would allow the entire system to operate as a self-contained device.

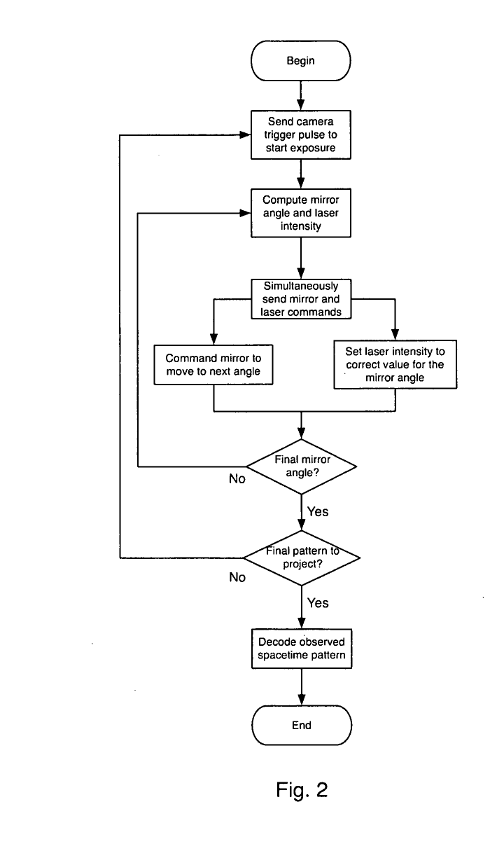

A laser and mirror controller 40 consists of dedicated high-speed electronics such as an AVR microcontroller, PIC chip, ARM processor or other embedded processor or general purpose computer, that are connected via a digital communications line 30 to a mirror driver 50, a laser light generator 60, and a camera 70. It is, however, within the scope of this disclosure to have the computer 20 and controller 40 to be implemented on the same hardware (e.g. an embedded CPU). Through the digital communications line 30, the computer 20 is able to modulate the brightness of the laser 60 and the angle of a mirror 80 by sending commands to the controller 40. In response to commands received from the laser and mirror controller 40, the laser 60 will output a plane of laser light 90 that varies in intensity between completely off (minimum brightness) and completely on (maximum brightness) and will also set the angle of the mirror 80 relative to the direction of the laser light 90. By varying the brightness of the plane of laser light 90 and angle of the mirror 80 through time, in conjunction with the shutter speed or capture window of the camera 70, 3D imaging information about the target object 130 may be captured using the procedure set forth in FIG. 2.

In a preferred embodiment, the mirror 80 is a commercially available galvanometer device (a “galvo”), which consists of a planar mirror attached to a magnetic voice coil driver. Varying the input voltage to the voice coil allows rapid and precise angular positioning of the mirror 80. Alternatively, however, it is anticipated that the plane of laser light 90 could be directed at a polyhedral object (not shown) having a plurality of mirrors 80 that reflect the plane of laser light 90 onto the target object 130. In this alternative embodiment, the polyhedral object (not shown) is rotated about its central axis at a constant or nearly constant velocity, which causes the plane of laser light 90 to oscillate back and forth over the target object 130 with known frequency.

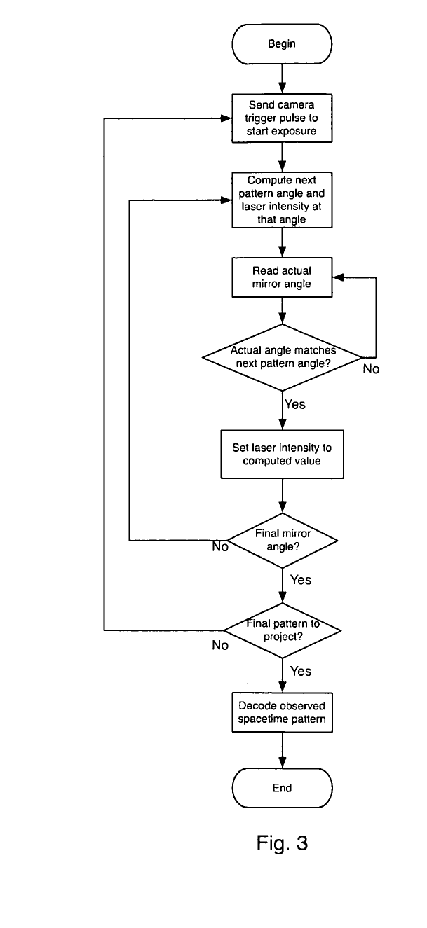

As illustrated in the flow chart in FIG. 3, this alternative embodiment would have an encoder (not shown) that allows the laser and mirror controller 40 to measure, rather than dictate, the instantaneous mirror angle and generate laser commands based on the measured angle.

The laser 60 is a diode laser, although other types of lasers could be used, with a line generating optic attached so that the output of the laser is a plane of laser light 90. The line generating optic may consist of a cylindrical, prismatic, fresnel lens, or other optic known in the art for producing laser lines; many commercial implementations of line generating lasers exist.

An additional alternative embodiment includes a laser 60 that is not filtered to create a plane of light. Instead, it emits a point of light and is aimed at a first polyhedral object with reflective surfaces or mirrors. As the first polyhedral object spins about its central axis, the point of light is reflected off the reflective surfaces or mirrors and results in a first reflected plane of light. This first reflected plane of light is directed at a second polyhedral object as in the preferred embodiment. It is believed that this alternative embodiment may have reduced distortion of the laser light as compared to the filtered version described in the preferred embodiment.

As would be apparent to those skilled in the art, it would also be possible to omit the mirror entirely and just move the laser source itself; however, such an implementation would be difficult to achieve practically for reasons including the relatively large rotational inertia of the laser (limiting the frequency bandwidth of the system) and the strain on laser wiring. The commercial market for both galvos and polygonal mirrors exists in large part due to the known limitations of physically moving laser light sources.

In a preferred embodiment, the camera 70 is a commercially availably CCD or CMOS camera that has an upload connection 110, such as a GigE Vision, Firewire, USB, analog video or any other digital or analog connection, with the computer 20 so that it can upload captured images either directly or through a mediator such as an image capture card or the like. The camera 70 also has a trigger input 100 capable of synchronizing the start of image exposure with an external trigger source transmitted from the laser and mirror controller 40. Preferably, the camera 70 also contains a monochrome CCD or CMOS imager that responds to a wide range of illumination frequencies, such as those available from Micron, Sony or Kodak. There are a large number of monochrome imaging chips presently on the market that can handle this requirement. The camera 70, however, need not be monochromatic however. Most color cameras use a filter pattern built onto the imager (CCD or CMOS) known as a Bayer pattern. Other filter patterns besides the Bayer pattern are possible. In the case of a color Bayer camera, the pixels that will produce useable measurements will be limited to those that can observe the specific frequency of laser light used. For instance, only the red pixels would observe red laser light. Given a sufficiently high-resolution camera, this would still result in a useable system.

With reference, again, to the preferred embodiment, the camera 70 also has an optical interference filter 120 matched to the frequency of the plane of laser light 90. The optical interference filter 120 is placed in front of the camera using a commercially available positioning apparatus such as a linear or rotary actuator and blocks all light except for the narrow frequency band that matches the plane of laser light 90, thereby dramatically increasing the signal-to-noise ratio of the 3D imaging system 10. Other filters may also be used to image red, green, and blue wavelengths in order to assign a color measurement to each pixel. The process of imaging selective wavelengths by means of indexed filters is well known in the art, and any filter frequency may be used.

FIG. 2 is a flow chart that demonstrates the procedure whereby the 3D imaging system of the present invention, described in FIG. 1, projects the plurality of frames that comprise the spacetime coding scheme onto a target object 130. The computer 20 sends the structure (on/off/on/on/on/off, for example) of a spacetime frame to the laser and mirror controller 40 via the control connection 30. The laser and mirror controller 40 sends a camera trigger command via the camera input 100 to the camera 70, which begins exposing a frame. The controller 40 simultaneously commands the mirror 80 to move to a particular angle corresponding to the next vertical stripe in the spacetime frame and the laser 60 to match the intensity of that stripe. The process of mirror 80 movement and laser 60 intensity modulation is repeated until all of the vertical stripes that comprise a particular spacetime frame have been projected. The exposure time of the camera 70 is set so that it exactly matches the total time required to project the plurality of stripes that comprise the spacetime frame. The frame projection procedure is repeated for each frame in the spacetime coding scheme, whereupon the scheme is decoded via known mathematical techniques to obtain 3D image information.

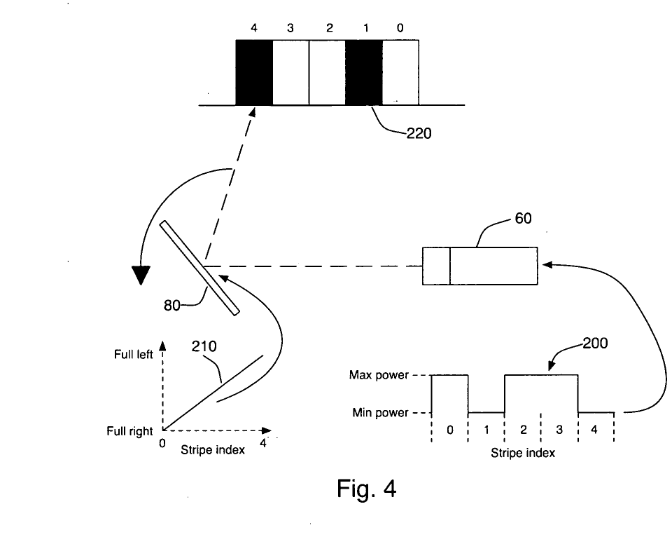

Additional detail about the projection process is demonstrated in FIG. 4. A laser modulation signal 200, here shown to consist of a binary pattern, causes the laser 60 to vary in intensity. The laser modulation signal 200 is synchronized with the mirror rotation signal 210, which causes the rotating mirror 80 to change its angle over time. As the intensity of the laser 60 changes and the mirror 80 rotates, a stripe pattern 220 is projected onto the target object (not shown) being scanned. The numbers 0 through 4 on FIG. 3 represent successive points in time.

In the preferred embodiment, the spacetime coding scheme consists of a plurality of images or frames, each of which consists of a plurality of stripes. The particular spacetime coding scheme may be either a binary code, a Gray code, a combination of Gray and binary coding, or any other coding scheme which assigns a discrete decoded illumination angle to a particular camera pixel when all observed images are combined to form an illumination time-history for each pixel in the camera. The particular cases of all stripes being displayed with maximum laser intensity or minimum laser intensity may be used to calibrate the camera response on a per-pixel basis to mitigate the influence of the target's surface properties on the decoding process. Once collected, the plurality of collected spacetime images can be decoded by any number of known mathematical algorithms.

In yet another alternative embodiment, the laser plane generator (the combination of the laser 60 and an optical line generator) may be replaced with a high intensity white light line generator. Such systems are commonly implemented using a white light source, photographic plate with a thin slit through which the light can pass, and optics to focus the resulting line. As compared to a laser, such a system would require an extremely powerful white light source and it would not be possible to use an interference filter to optically isolate the illumination pattern from background (white light) illumination. Such a line generator would, however, not be subject to the speckle problems that are known to exist with coherent illumination sources like lasers. Further in this embodiment, however, color cameras may be used since all pixels will respond to white light.

The present invention offers the following advantages:
1. High Speed—The structured light architecture enables greatly reduced scan times compared to the existing state of the art line stripe scanners. This method and apparatus of the present invention is easily scaleable to higher resolution systems with minimal impact on total time. Each time the resolution is doubled, the total time (@ 30 frames per second) is increased by only 33 milliseconds.
2. Excellent Depth-of-Focus—Laser illumination will provide large depth of focus and minimize blurring at the edge of the projected pattern or object edge. Unlike a projector-based white light system, lasers offer the ability to project a collimated beam that diverges only slightly with distance.
3. Low Noise—Projector based systems operate best in a dimly light room to maximize contrast and detection of the projected image. A laser system, coupled with a matched optical filter is much less susceptible to ambient light, thereby greatly reducing system noise and error. Moreover, the present invention allows the use of arbitrary spacetime encoding schemes, which are more robust against measurement noise than purely spatial (e.g. phase) encodings.
4. Lower Cost—Projectors are significantly more expensive than a laser diode coupled with simple high-speed rotary mechanism. The cost of a replacement bulb alone, much less a complete projector, far outweighs the cost of the diode mechanism. Laser control systems are widely deployed in low-cost consumer electronics such as laser printers.
5. Smaller Size—Laser diodes, associated optics and control electronics can be bundled onto a single circuit board, along with all camera detection electronics. The total package won't be much bigger than a consumer digital camera. This would yield a total scan system much smaller than even the smallest commercially available off-the-shelf video projector.
6. Absolute depth measurements. The present invention produces absolute depth measurements rather than a phase map, and therefore is useful even when the object being scanned has large height changes and/or topologically disconnected pieces that prevent phase unwrapping from working correctly.

All of the references cited herein are incorporated by reference in their entirety.

It is emphasized that the Abstract is provided to comply with 37 C.F.R.§1.72(b) requiring an Abstract that will allow the reader to quickly ascertain the nature and gist of the technical disclosure. It is submitted with the understanding that it will not be used to interpret or limit the scope or meaning of the claims

In the foregoing Detailed Description, various features are grouped together in a single embodiment to streamline the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

It will be readily understood to those skilled in the art that various other changes in the details, material, and arrangements of the parts and method stages which have been described and illustrated in order to explain the nature of this invention may be made without departing from the principles and scope of the invention as expressed in the subjoined claims.

What is claimed is:

1. A system for three-dimensional imaging of a target object comprising:
a light source;
a light source controller for modulating the intensity of the light from the light source;
at least one reflective surface for reflecting light from the light source onto the target object;
a reflective surface controller for altering an angle of the at least one reflective surface relative to the target object such that modulated reflected light is periodically swept across the target object to be imaged; each such periodic sweep displaying a stripe pattern on the target object;
a detection means for capturing and recording each stripe pattern;
a processor for varying the stripe patterns over time to record a plurality of stripe patterns with the detection means;
whereby the plurality of stripe patterns forms a spacetime coding scheme that can be analyzed to yield a three-dimensional image of the target object.

2. The system of claim 1, wherein the light source is a laser.

3. The system of claim 2, wherein the light source includes a line stripe generator.

4. The system of claim 1, wherein the light source controller modulates the intensity of the light in a predetermined pattern.

5. The system of claim 4, wherein the predetermined pattern comprises one frame of the spacetime coding scheme.

6. The system of claim 5, wherein the spacetime coding scheme constitutes a Gray code.

7. The system of claim 5, wherein the spacetime coding scheme constitutes a binary code.

8. The system of claim 1, wherein the at least one reflective surface is a galvanometer

9. The system of claim 1, wherein the at least one reflective surface is a polyhedral object having a plurality of reflective surfaces and spins about a central axis.

10. The system of claim 1, wherein the detection means comprises a camera that records each stripe pattern on a plurality of pixels.

11. The system of claim 10, wherein the plurality of stripe patterns comprise a time-history for the plurality of pixels whereby discrete illumination angles can be calculated.

12. A system for generating a three-dimensional image of a target object, comprising:
a rotating planar light source for projecting a plurality of time-varying patterns onto a target object, wherein each of the plurality of patterns is comprised of a plurality of stripes of varying intensity; each plurality of stripes comprising a pattern that varies through time;
a camera for capturing a plurality of images of the target object illuminated by the plurality of patterns projected by said planar light source, said plurality of images comprised of a plurality of pixels;
a controller for triggering the camera to begin exposing an image and modulating said planar light source while simultaneously causing the light source to sweep across the target object, the camera exposure occupying the period of time where the modulating light pattern is in motion, thereby causing the camera to capture one of the plurality of images of the plurality of projected patterns;
a processor for decoding the plurality of images of the plurality of projected patterns to derive an illumination angle for each pixel relative to said light source; said processor further using said illumination angle for each pixel to triangulate a plurality of distance measurements from said camera to said target object.

13. A method for three-dimensional imaging of a target object, comprising:
periodically sweeping a plane of light across the target object;
modulating the intensity of the plane of light in a predetermined pattern as it sweeps across the target object;
recording an entire sweep of the plane of light across the target object in a single image to create a stripe pattern;
collecting a plurality of images of stripe patterns displayed on the target object through time; and
extracting three-dimensional image data from the plurality of images of stripe patterns; whereby a three-dimensional image of the target object can be created.

14. The method of claim 13, wherein the plane of light is created by a laser or a line stripe generator.

15. The method of claim 13, wherein the plurality of images of stripe patterns comprises a spacetime coding scheme.

16. The method of claim 13, wherein the spacetime coding scheme is a Gray code.

17. The method of claim 13, wherein the spacetime coding scheme is a binary code.

18. The method of claim 13, wherein the plurality of images of stripe patterns are comprised of a plurality of pixels

19. The method of claim 18, wherein the step of extracting three-dimensional image data further comprises deriving an illumination angle for each of the plurality of pixels relative to the light source.

20. The method of claim 19, further comprising using the illumination angle for each of the plurality of pixels to derive a plurality of distance measurements from the camera to the target object.
